(19) United States
(12) Patent Application Publication
(10) Pub. No.: US 2024/0095634 A1
(43) Pub. Date: Mar. 21, 2024

(54) DIGITAL FOOTPRINT FOR EMPLOYEE SAFETY

(71) Applicant: International Business Machines Corporation, Armonk, NY (US)

(72) Inventors: Srini Bhagavan, LENEXA, KS (US); Prasanna Alur Mathada, BANGALORE (IN); Hrishikesh Sujaya Kumar, BANGALORE (IN); Thuan D. Ngo, San Jose, CA (US)

(21) Appl. No.: 17/949,011

(22) Filed: Sep. 20, 2022

(51) Int. Cl. G06Q 10/06; G06F 11/32

(52) U.S. Cl. CPC G06Q 10/0635; G06F 11/327

(57) ABSTRACT

An example operation may include one or more of ingesting data records from a plurality of external data sources via a plurality of API calls, generating a plurality of digital footprints for a plurality of users, respectively, which have access to a common finite space, wherein each digital footprint includes a respective health value of a respective user generated based on ingested data records of the user, identifying a user from among the plurality of users which is about to enter the common finite space, in response to identifying the user, determining a cumulative safety value for the common finite space based on the digital footprint of the identified user and a digital footprint of one or more other users already present within the common finite space, and transmitting an alert to a computing system based on the determined cumulative safety value for the common finite space.

### BACKGROUND

During a previous study, researchers in Arizona placed a non-pathogenic virus on a door handle of an open door within a workspace that included a large floor with central seating and cubicles filled without approximately 80 employees. Within four hours, over half (50%) of the common surfaces within the office had been contaminated with some form of the virus. By the end of the day, every surface that was tested had some trace of the virus including coffee pots, bathrooms, cabinets, and a break room. However, identifying the risk of contamination within an unsuspecting office is a very difficult task. Many employees are not aware of when they are exposed to someone who is a potential health risk until well after the fact. Furthermore, some illnesses may affect certain types of people with certain conditions more than it does other people who do not have such conditions. Accordingly, what is needed is a way to improve the health and safety of employees in a large workspace.

### SUMMARY

One example embodiment provides an apparatus that may include a processor configured to ingest data records from a plurality of external data sources via a plurality of application programming interface (API) calls, and a memory configured to store the ingested data records, wherein the processor is further configured to one or more of generate a plurality of digital footprints for a plurality of users, respectively, which have access to a common finite space, wherein each digital footprint comprises a respective health value of a respective user generated based on ingested data records of the user, identify a user from among the plurality of users which is about to enter the common finite space, in response to identification of the user, determine a cumulative safety value for the common finite space based on the digital footprint of the identified user and a digital footprint of one or more other users already present within the common finite space, and transmit an alert to a computing system based on the determined cumulative safety value for the common finite space.

Another example embodiment provides a method that includes one or more of ingesting user data records from a plurality of external data sources via a plurality of application programming interface (API) calls, generating a plurality of digital footprints for a plurality of users, respectively, which have access to a common finite space, wherein each digital footprint comprises a respective health value of a respective user generated based on ingested data records of the user, identifying a user from among the plurality of users which is about to enter the common finite space, in response to identifying the user, determining a cumulative safety value for the common finite space based on the digital footprint of the identified user and a digital footprint of one or more other users already present within the common finite space, and transmitting an alert to a computing system based on the determined cumulative safety value for the common finite space.

A further example embodiment provides a computer-readable medium comprising instructions, that when read by a processor, cause the processor to perform one or more of ingesting user data records from a plurality of external data sources via a plurality of application programming interface (API) calls, generating a plurality of digital footprints for a plurality of users, respectively, which have access to a common finite space, wherein each digital footprint comprises a respective health value of a respective user generated based on ingested data records of the user, identifying a user from among the plurality of users which is about to enter the common finite space, in response to identifying the user, determining a cumulative safety value for the common finite space based on the digital footprint of the identified user and a digital footprint of one or more other users already present within the common finite space, and transmitting an alert to a computing system based on the determined cumulative safety value for the common finite space.

### BRIEF DESCRIPTION OF THE DRAWINGS

FIG. 1A is a diagram illustrating a computing environment according to an example embodiment.

FIG. 1B is a diagram illustrating a cloud computing environment according to an example embodiment.

FIG. 2A is a diagram illustrating abstraction model layers according to an example embodiment.

FIG. 2B is a diagram illustrating a system for tracking a digital footprint in a finite space according to an example embodiment.

FIG. 3A is a diagram illustrating a permissioned network according to an example embodiment.

FIG. 3B is a diagram illustrating another permissioned network according to an example embodiment.

FIG. 3C is a diagram illustrating a further permissionless network according to an example embodiment.

FIG. 3D is a diagram illustrating machine learning process via a cloud computing platform according to an example embodiment.

FIG. 3E is a diagram illustrating a quantum computing environment associated with a cloud computing platform according to an example embodiment.

FIG. 4A is a diagram illustrating a process of ingesting records of user data according to an example embodiment.

FIG. 4B is a diagram illustrating a process of identifying a health risk to users within a finite space using a digital footprint according to an example embodiment.

FIG. 4C is a diagram illustrating a user interface displaying a health score for each of a plurality of finite spaces according to an example embodiment.

FIG. 5 is a diagram illustrating a method of determining safety based on a digital footprint according to an example embodiment.

FIG. 6 is a diagram illustrating an example system that supports one or more of the example embodiments.

### DETAILED DESCRIPTION

It is to be understood that although this disclosure includes a detailed description of cloud computing, implementation of the teachings recited herein is not limited to a cloud computing environment. Rather, embodiments of the present invention are capable of being implemented in conjunction with any other type of computing environment now known or later developed.

Different jurisdictions/locations (e.g., countries, states, cities, etc.) may have their own methods and working style to zero in on the Covid-19 positive patient. When identified, the potential positive patients may be interacted with/interviewed about their travel history and people/places they visited in the last few weeks. This can help trace or track down other people who may have been exposed to the positive patient. However, up to this point, the process has been largely manual and relies on the Covid-19 positive person coming forward with details about their illness and about the people and places they visited. However, the sick person may not recollect or may provide incorrect location/time details, that might derail the process of identifying other persons at risk.

The example embodiments are directed to a system that can generate a digital footprint for each user within a shared environment (e.g., an office, a school or other learning environment, an event, a building, a home, etc.) The system can ingest data records from various sources including public databases, medical databases, doctor's offices, employment databases, travel databases, fillable forms, and the like, which include information about people who have tested positive for an illness such as Covid 19 or any other transmissible health risk. For example, a person may authorize the host system to access this data on their behalf or the data may be provided in a document or other form filled out by the user via a computer or any other means. The host system may process the ingested data and determine a digital footprint for each user. The digital footprint may include specific health-related attributes of the respective user such as pre-existing conditions, known medications, current health status (if known), a health value/score, and the like. Each digital footprint may also be uniquely linked to a particular user for example using a unique identifier or the like.

The host system may also connect to various devices and sensors within the shared environment such as keypads, cameras, kiosks, door locks, routers, computers, and the like. The host system may receive data captured from the various devices to track a movement or a location of a user as they move within the shared environment. For example, within the shared environment (such as an office) there may be multiple enclosed finite spaces such as conference rooms, meeting rooms, bathrooms, break rooms, cubicle farms, classrooms, and the like. The host system may determine a health risk associated with each finite space within the shared environment based on the people that are within the finite spaces.

The host system may detect when multiple users are interacting or are about to interact with each other within a shared finite space and determine whether or not such interaction is a possible health risk to one or more of the users within the shared finite space. In particular, a cumulative health score may be determined using the digital footprints of each of the multiple users. When a potential health risk is detected, the host system may generate an alert and transmit the alert to a mobile phone of one or more of the multiple users. As another example, the host system may prevent a door to the shared finite space from being opened (e.g., even when a user has entered the correct keycode, etc.) As another example, the host system may transmit an alert to an administrator's device when the potential risk is detected.

The system described herein can help organizations maintain employee safety within a finite space, by means of cumulative values obtained by means of digital footprint. Each individual employee's digital footprint equates to a certain score, considering various governing parameters, deemed valid and a necessity by the organization. The organization may define thresholds on acceptable/not acceptable values and also identify a finite space/zone that is to be watched/monitored for health safety. For example, when a user (e.g., employee) is about to enter/exit a shared finite space (e.g., inputting a keycode into a keypad, swiping a key card, being detected/recognized on camera, etc.) the system may determine an average safety score for the shared finite space based on the user about to enter the room and determine whether or not to all the user into the room. The system can generate an appropriate alert, recommending adequate measures and plan of actions to maintain safety. If available, a chief health officer (CHO) or other medical professional within the organization can evaluate and approve the system's actions, to further justify/modify future recommendations. Furthermore, the system can focus on a particular issue in hand, without targeting individuals and avoid being non-judgmental or biased without repercussions.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

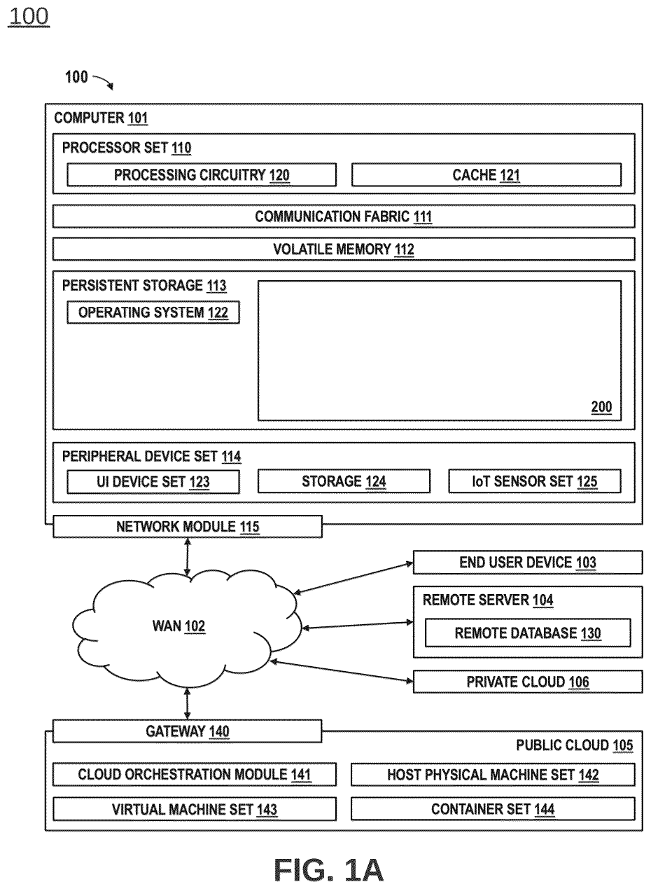

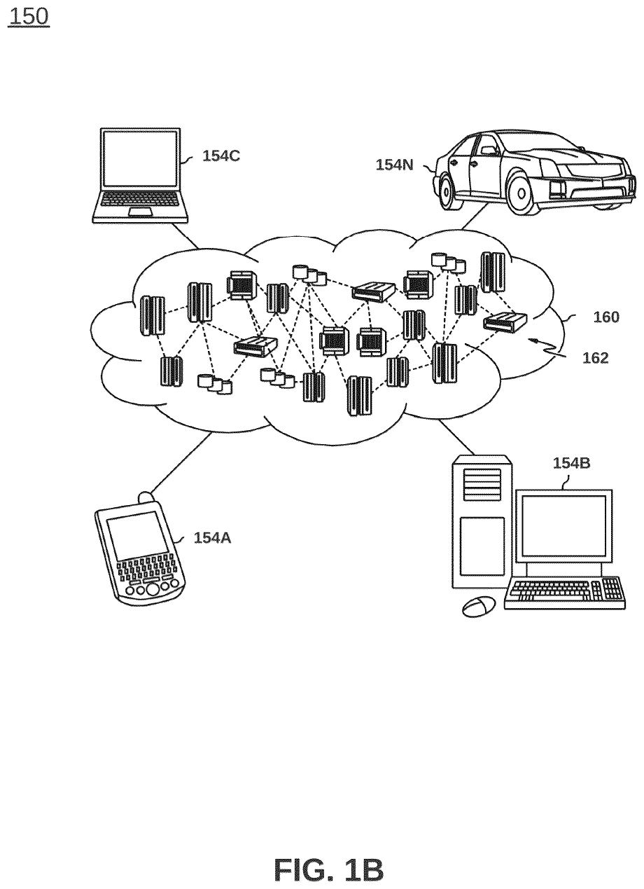

Referring now to FIG. 1A, a computing environment 100 is depicted. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for executing at least some of the computer code involved in performing the inventive methods, such as a digital footprint application 200 that can track users in a shared environment and detect potential health risks that occur from users interacting or possibly interacting and generate remedial actions including alerts, locking doors, and the like. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric comprises switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

Referring now to FIG. 1B, an illustrative cloud environment 150 is depicted. As shown, cloud computing environment 160 includes one or more cloud computing nodes 162 with which local computing devices used by cloud consumers, such as, for example, personal digital assistant (PDA) or cellular telephone 154A, desktop computer 154B, laptop computer 154C, and/or automobile computer system 154N may communicate. Nodes 162 may communicate with one another. They may be grouped (not shown) physically or virtually in one or more networks, such as Private, Community, Public, or Hybrid clouds as described hereinabove, or a combination thereof. This allows cloud computing environment 160 to offer infrastructure, platforms and/or software as services for which a cloud consumer does not need to maintain resources on a local computing device. It is understood that the types of computing devices 154A-N shown in FIG. 1B are intended to be illustrative only and that computing nodes 162 and cloud computing environment 160 can communicate with any type of computerized device over any type of network and/or network addressable connection (e.g., using a web browser).

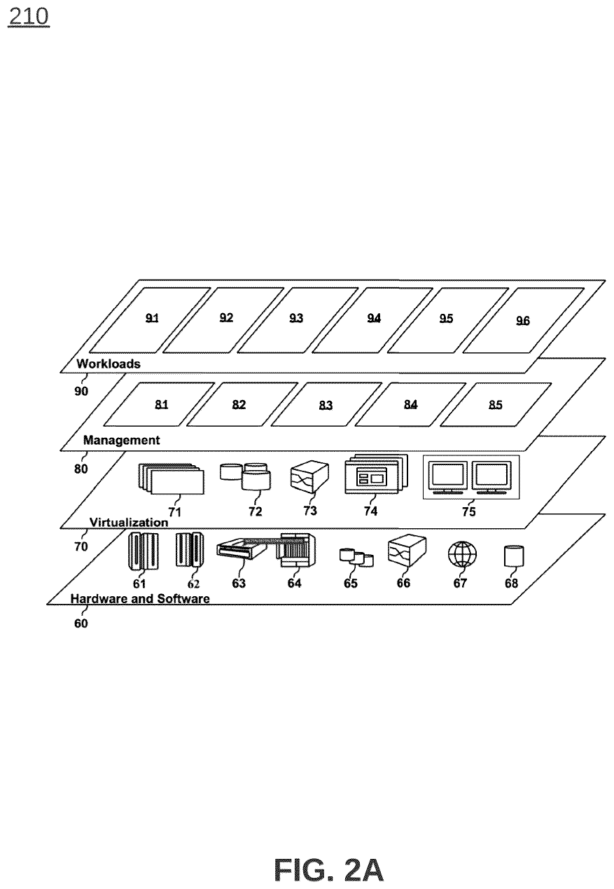

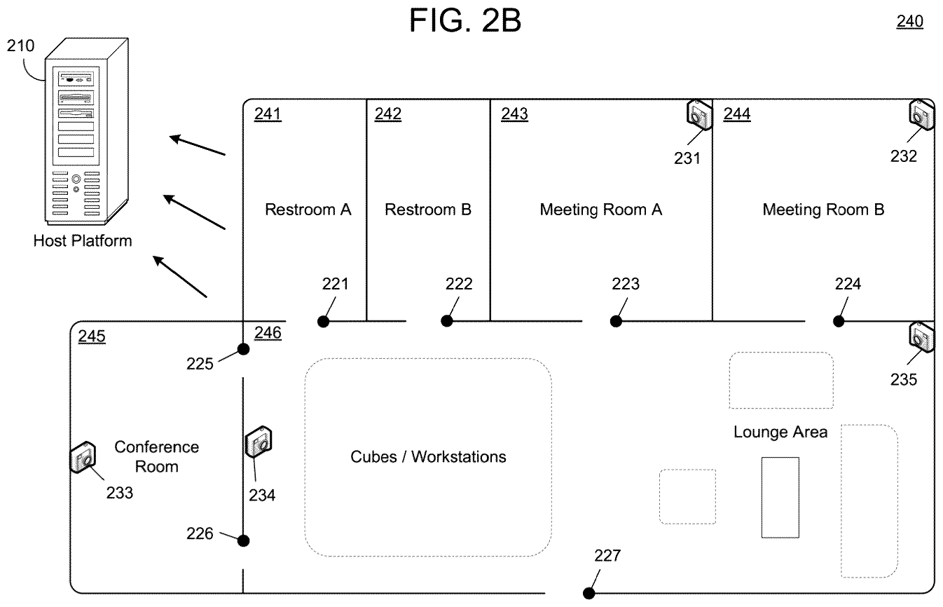

Referring now to FIG. 2A, a set of functional abstraction layers 210 provided by cloud computing environment 160 (FIG. 1B) is shown. It should be understood in advance that the components, layers, and functions shown in FIG. 2A are intended to be illustrative only, and embodiments of the invention are not limited thereto. As depicted, the following layers and corresponding functions are provided: Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68. Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing to consume these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and digital footprint system 96.

FIG. 2B illustrates a further description of the digital footprint system 96 shown in FIG. 2A according to example embodiments. Referring to FIG. 2B, a shared environment 240 is shown which includes an office space with a plurality of rooms 241, 242, 243, 244, 245, and 246. Each of the rooms may have one or more finite spaces that are monitored. For example, each of rooms 241, 242, 243, 244, and 245 may each be analyzed as individual enclosed finite spaces, respectively. Meanwhile, room 246 is a larger room with multiple areas of aggregation including cubes/workstation area and a lounge area. Here, the cubes/workstation area may be monitored independently from the lounge area. Thus, two areas of interest are within one enclosed finite space (i.e., room 246).

The digital footprint application may be hosted by a host platform 210 such as a cloud platform, an on-premises server, a hybrid platform, or the like. The type of host is not limited. The size, location, and other details of the rooms 241-246 may be registered with the host platform 210 in advance, for example, via an administrator of the office space. Furthermore, each of the potential users of the shared environment 240 may be registered in advance as well. For example, each user may receive a handout or form that provides a list of questions about their current health conditions. Questions may include, but are not limited to, whether the user has been vaccinated, the data of the most recent vaccination, travel history information such as any travel in the last two weeks, etc., current health classification (e.g., green, yellow, red, etc.) of the geographical location of the user (e.g., the city or state where they live, etc.) The questions may also include information about recent hospital stays, any medications that the user is currently taking, any pre-existing medical conditions, etc. In addition, although not shown in FIG. 2B, the host platform 210 may ingest additional data records from any desired location including airports, medical databases, employment databases, publicly available databases, and the like, which include additional information about the health statuses of the user. Based on the values entered by the user in response to the questions and/or the data ingested from third-party sources, the host platform 210 may generate a digital footprint for each user including the details of their answers/ingested data as well as a health score for the user based on their answers/ingested data.

The host platform 210 may also be registered with various access points 221, 222, 223, 224, 225, 226, and 227 within the shared environment 240 such as keypads, door locks, routers and network equipment, etc. that enable the host platform 210 to track the movements of the users within the share environment 240. For example, the user can be tracked based on their keycard swipes or keypad inputs as they enter new rooms. This also lets the host platform 210 know that the user has left a previous room. As another example, the host platform 210 may include an IP location tracing software program that can detect when a user has moved based on their IP address as they move from one room to another (e.g., from one hot spot in the office to another, etc.) and connect to different areas of the network within the shared environment 240.

The health score of a user may be updated each time the user exits a finite space and enters another finite space within the shared environment 240. For example, a user may be located in the lounge area of the room 246. When the user leaves the lounge area and swipes their keycard on a keypad of room 245, the swipe may be detected by the host platform 210. Here, the host platform 210 may communicate with the keypad using a wired or wireless connection that sends a signal to the host platform 210 to identify not only the location of the access but a unique identifier of the user which may be obtained from the keycard. In response, the host platform 210 identifies the user and their current health score based on the unique identifier. The host platform 210 may also know of other users that are already present in the room 245. Here, the host platform 210 may compare the digital footprint of the user about to enter the room 245 with the digital footprint of the one or more users already present within the room 245 to determine whether or not to allow the user access to the room 245. As another example, the host platform 210 may automatically allow access to the room 245 regardless of the health analysis, but also send an alert to a mobile device of the user, a mobile device of any of the users in the room 245, an alert to an administrator computer, or the like.

Although not shown in FIG. 2B, the tracking may be performed using various devices within and associated with the shared environment 240. For example, each user may have a badge or keycard that is assigned a unique identifier which uniquely identifies the user assigned to the badge. The host platform 210 may also host a cognitive recognition service that can identify users via visual recognition based on a camera feed (including a live camera feed) from any cameras within the shared environment 240 such as cameras 231, 232, 233, 234, and 235. In this example, the user can be tracked using any of the cameras 231-235 and facial recognition software of the cognitive system or the like that tracks the user's movements within certain areas of the shared environment 240.

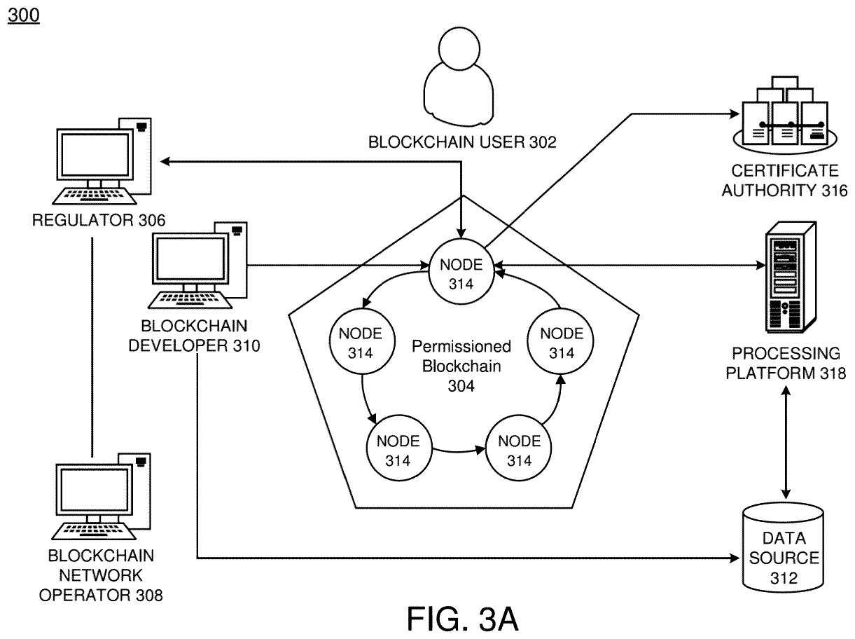

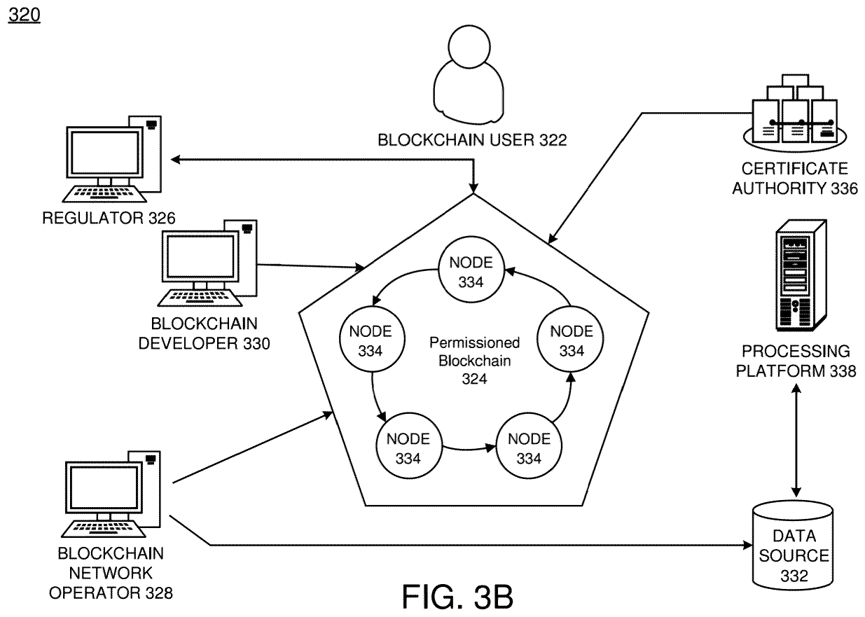

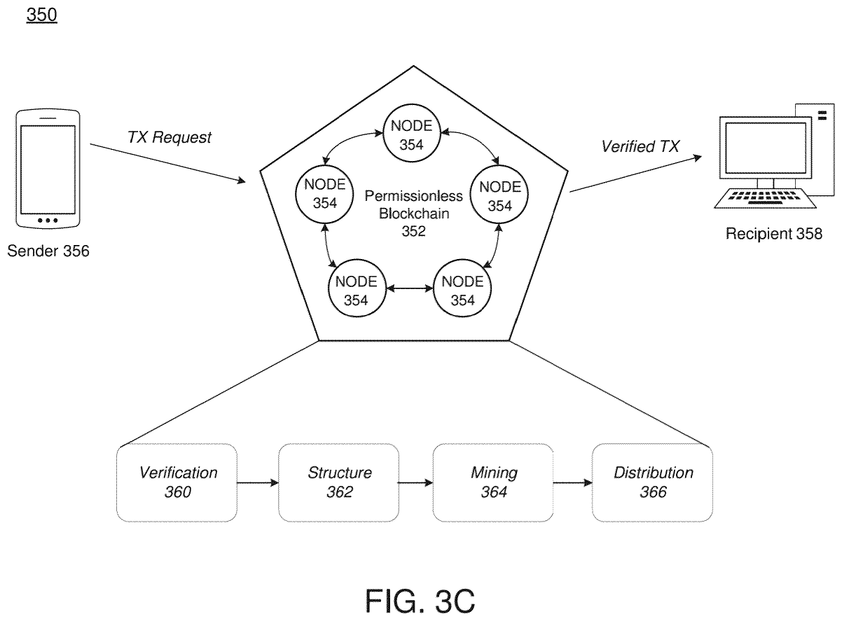

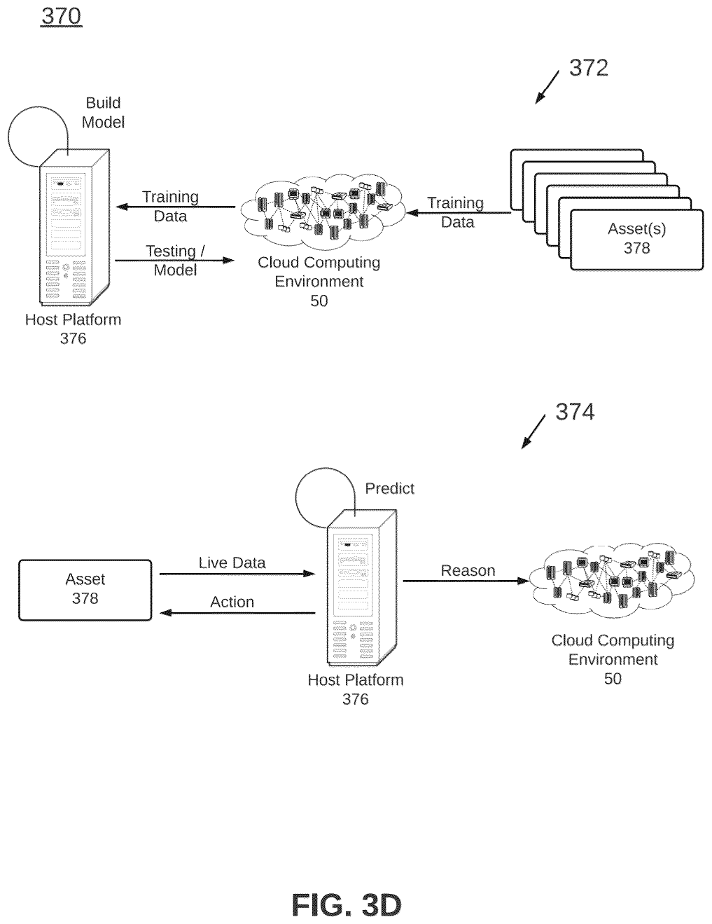

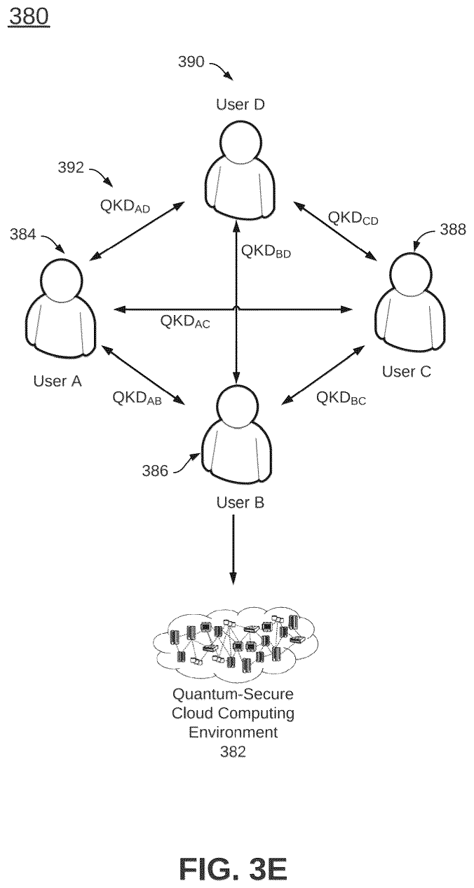

FIG. 3A illustrates an example of a permissioned blockchain network 300, which features a distributed, decentralized peer-to-peer architecture. The blockchain network may interact with the cloud computing environment 160, allowing additional functionality such as peer-to-peer authentication for data written to a distributed ledger. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client”. An auditor could be restricted only to querying the ledger, whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client”. An auditor could be restricted only to querying the ledger, whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains, which require permission to join, anyone can join a permissionless blockchain. For example, to join a permissionless blockchain a user may create a personal address and begin interacting with the network by submitting transactions and hence adding entries to the ledger. Additionally, all parties have the choice of running a node on the system and employing the mining protocols to help verify transactions.

FIG. 3C illustrates a process 350 of a transaction being processed by a permissionless blockchain 352, including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters, the nodes verify 360 the transaction based on rules (which may be pre-defined or dynamically allocated) established by the permissionless blockchain 352 creators. For example, this may include verifying the identities of the parties involved, etc. The transaction may be verified immediately or it may be placed in a queue with other transactions, and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256-bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW, thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution 366, the successfully validated block is distributed through the permissionless blockchain 352, and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

FIGS. 3D and 3E illustrate additional examples of use cases for cloud computing that may be incorporated and used herein. FIG. 3D illustrates an example 370 of a cloud computing environment 160, which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 3D, a host platform 376, builds and deploys a machine learning model for predictive monitoring of assets 378. Here, the host platform 366 may be a cloud platform, an industrial server, a web server, a personal computer, a user device, and the like. Assets 378 can be any type of asset (e.g., machine or equipment, etc.) such as an aircraft, locomotive, turbine, medical machinery and equipment, oil and gas equipment, boats, ships, vehicles, and the like. As another example, assets 378 may be non-tangible assets such as stocks, currency, digital coins, insurance, or the like.

The cloud computing environment 160 can be used to significantly improve both a training process 372 of the machine learning model and a predictive process 374 based on a trained machine learning model. For example, in 372, rather than requiring a data scientist/engineer or another user to collect the data, historical data may be stored by the assets 378 themselves (or through an intermediary, not shown) on the cloud computing environment 160. This can significantly reduce the collection time needed by the host platform 376 when performing predictive model training. For example, data can be directly and reliably transferred straight from its place of origin to the cloud computing environment 160. By using the cloud computing environment 160 to ensure the security and ownership of the collected data, smart contracts may directly send the data from the assets to the individuals that use the data for building a machine learning model. This allows for sharing of data among the assets 378.

Furthermore, training of the machine learning model on the collected data may take rounds of refinement and testing by the host platform 376. Each round may be based on additional data or data that was not previously considered to help expand the knowledge of the machine learning model. In 372, the different training and testing steps (and the associated data) may be stored on the cloud computing environment 160 by the host platform 376. Each refinement of the machine learning model (e.g., changes in variables, weights, etc.) may be stored in the cloud computing environment 160 to provide verifiable proof of how the model was trained and what data was used to train the model. For example, the machine learning model may be stored on a blockchain to provide verifiable proof. Furthermore, when the host platform 376 has achieved a trained model, the resulting model may be stored on the cloud computing environment 160.

After the model has been trained, it may be deployed to a live environment where it can make predictions/decisions based on executing the final trained machine learning model. For example, in 374, the machine learning model may be used for condition-based maintenance (CBM) for an asset such as an aircraft, a wind turbine, a healthcare machine, and the like. In this example, data fed back from asset 378 may be input into the machine learning model and used to make event predictions such as failure events, error codes, and the like. Determinations made by executing the machine learning model at the host platform 376 may be stored on the cloud computing environment 160 to provide auditable/verifiable proof. As one non-limiting example, the machine learning model may predict a future breakdown/failure to a part of the asset 378 and create an alert or a notification to replace the part. The data behind this decision may be stored by the host platform 376 and/or on the cloud computing environment 160. In one embodiment, the features and/or the actions described and/or depicted herein can occur on or with respect to the cloud computing environment 160.

FIG. 3E illustrates an example 380 of a quantum-secure cloud computing environment 382, which implements quantum key distribution (QKD) to protect against a quantum computing attack. In this example, cloud computing users can verify each other's identities using QKD. This sends information using quantum particles such as photons, which cannot be copied by an eavesdropper without destroying them. In this way, a sender and a receiver through the cloud computing environment can be sure of each other's identity.

In the example of FIG. 3E, four users are present 384, 386, 388, and 390. Each pair of users may share a secret key 392 (i.e., a QKD) between themselves. Since there are four nodes in this example, six pairs of nodes exist, and therefore six different secret keys 392 are used, including QKD_{AB}, QKD_{AC}, QKD_{AD}, QKD_{BC}, QKD_{BD}, and QKD_{CD}. Each pair can create a QKD by sending information using quantum particles such as photons, which cannot be copied by an eavesdropper without destroying them. In this way, a pair of users can be sure of each other's identity.

The operation of the cloud computing environment 382 is based on two procedures (i) creation of transactions and (ii) construction of blocks that aggregate the new transactions. New transactions may be created similar to a traditional network, such as a blockchain network. Each transaction may contain information about a sender, a receiver, a time of creation, an amount (or value) to be transferred, a list of reference transactions that justifies the sender has funds for the operation, and the like. This transaction record is then sent to all other nodes, where it is entered into a pool of unconfirmed transactions. Here, two parties (i.e., a pair of users from among 384-390) authenticate the transaction by providing their shared secret key 392 (QKD). This quantum signature can be attached to every transaction, making it exceedingly difficult to be tampered with. Each node checks its entries with respect to a local copy of the cloud computing environment 382 to verify that each transaction has sufficient funds.

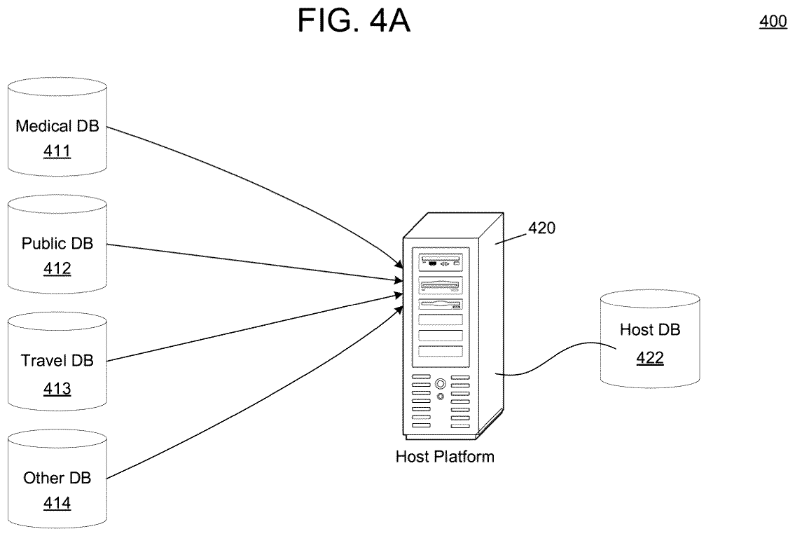

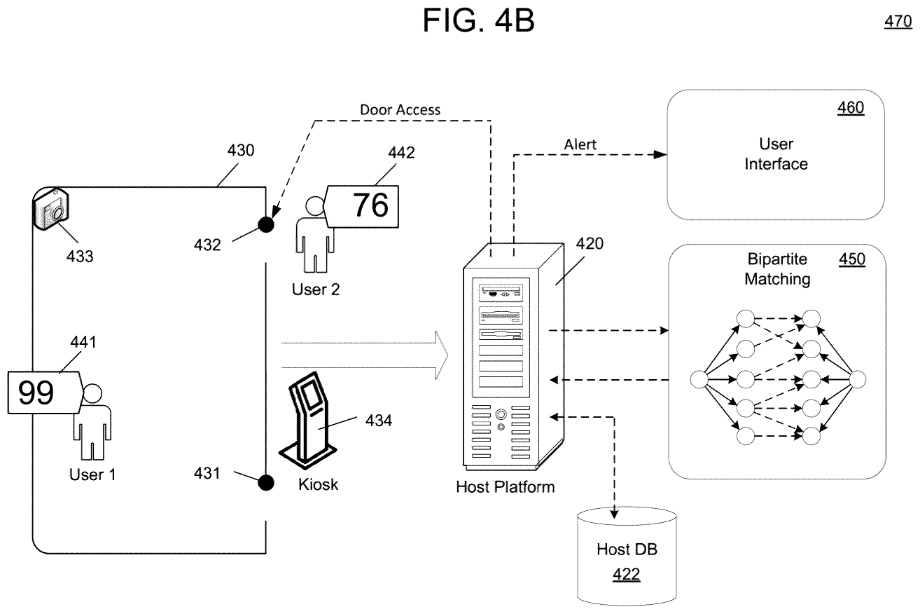

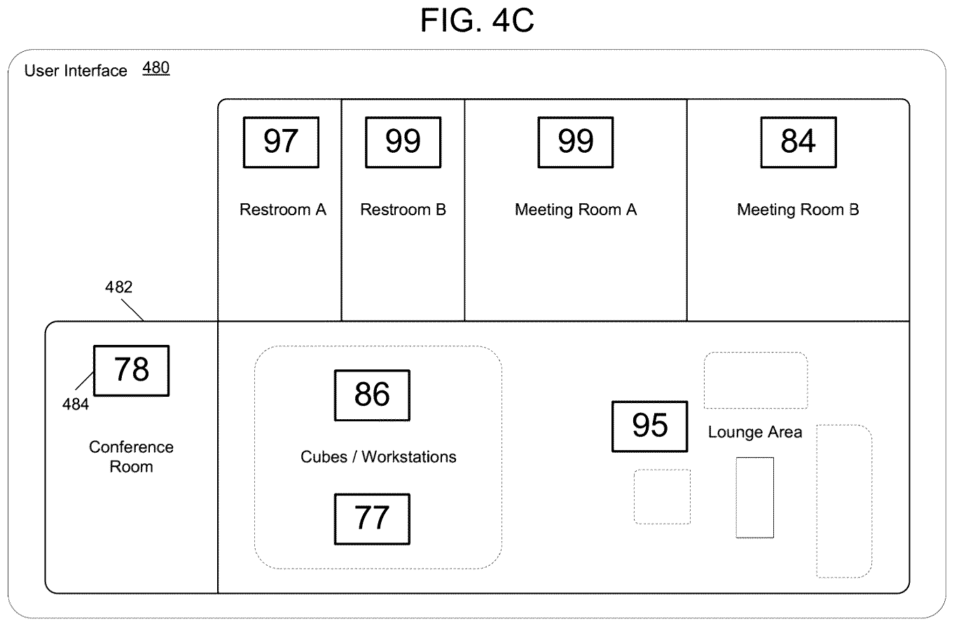

FIG. 4A illustrates a process 400 of ingesting data records of user data according to an example embodiment. Referring to FIG. 4A, a host platform 420 may host a digital footprint software application that can track user movements within an enclosed area and identify potential health risks in confined finite spaces. The host platform 420 may ingest data records from various sources of truth including a medical database 411, a publicly available database 412 such as an authority or other agency, a travel database 413 such as safety databases of various airports, train stations, bus stations, and the like. The host platform 420 may also ingest data records from any other source of data such as a database 414.

The data records may have information about Covid-19 infected users including users who have recently tested positive for Covid-19 (e.g., within the last 30 days, etc.) and users who have recently been exposed to others that are positive for Covid-19. The data records may also provide information about which geographical areas of the state/country are the current hot spots. It should be appreciated that Covid-19 is just one example and any type of spreadable/transmissible health risk can be tracked using the example embodiments. Furthermore, underlying health conditions and pre-existing conditions of the users may also be obtained by the ingesting process. Before accessing this data from the databases 411-414, the host platform 420 may receive express authorization from the users and/or the employer.

The ingesting process may include generating and transmitting one or more application programming interface (API) calls to one or more APIs of the databases 411-414. The API calls may identify particular users (by name) or any other identifier known such as social security number, home residence address, work address, date of birth, and the like. The API calls may be performed on a repeating/iterative basis such as once a day, once every few hours, etc. This enables the host platform 420 to continually update the health status of the users within the shared environment. The obtained data records may be stored within a host database 422 of the host platform 420.

FIG. 4B illustrates a process 470 of identifying a health risk to users within a finite space using a digital footprint according to an example embodiment. Referring to FIG. 4B, a user 442 is being monitored in association with a finite space 430 within a shared environment (not shown) such as an office space, a school, a building, or the like. Here, the user 442 is approaching a door 432 of the finite space 430. The user's movements may be detected by a camera 433 in room 430 or in a hallway outside the finite space 430. As another example, the user's movement may be detected by an IP address of the user being changed by the network within the shared environment. As another example, the user's movements may be detected by the user swiping a key card or badge on an access point/keypad of the door 432. As yet another example, the user 442 may swipe their badge or type in their keycode on a kiosk 434 which provides the user 442 with their up-to-date health score before they attempt to enter the finite space 430.

In this example, the finite space 430 already includes another user (user 441) that is present within the finite space 430. When the host platform 420 detects the user 442 is attempting to enter the finite space 430, the host platform 420 may determine whether or not such access is a potential health risk. Here, the host platform 420 may compare the digital footprint of the user 442 attempting to enter the finite space 430 with a digital footprint of the user 441 already present in the finite space 430 to determine an overall health score for the finite space 430 should the user 442 enter the room/finite space 430. As one example, the health scores of the two users may be averaged to identify a total health score for the finite space 430.

It should also be understood that a more complex analysis may also be performed by the host platform 420. For example, a machine learning model or a bipartite graph may be used to match together attributes of the user 442 and the user 441 to determine an overall health score for the finite space 430 should the user 442 be allowed to enter the finite space 430. As an example, bipartite matching may be used to deduce a score for the finite space 430 using a cumulative score that is generated by comparing criteria of the user 442 against criteria of the user 441. The result is a total score for the finite space 430.

After determining the health score for the finite space 430, the host platform 420 may compare the health score to a predefined score threshold to determine whether the combination of users in the finite space 430 together is a potential health risk to one or more of the users. If it is, the host platform 420 can take multiple actions including, but not limited to, locking the door 432 to the finite space 430 to prevent the user 442 from entering the finite space 430, sending an alert or a warning to a mobile device of the user 442 and/or the user 441, sending an alert or warning to an administrator machine such as an office health administrator, causing an alarm or other alert to be issued within the finite space 430 or outside the finite space 430, and the like.

As another example, if the host platform 420 determines that the user 442 entering the finite space 430 with user 441 already present is not a health risk, the host platform 420 may continue to monitor the interaction and also if any other users enter the room or if any of the user 441 and the user 442 leave the room. If the two users 441 and 442 are in the finite space 430 together for a predetermined period of time (e.g., 5 minutes, 15 minutes, 30 minutes, etc.) the host platform 420 may modify the health scores of the respective users 441 and 442 within their respective digital footprints based on the health risks exposed to the respective users by the other. Furthermore, when the user 442 leaves the finite space 430, the host platform 420 may generate a new score for the finite space 430.

FIG. 4C illustrates a user interface 480 displaying a health score for each of a plurality of finite spaces within a shared environment according to an example embodiment. Referring to FIG. 4C, the host platform 420 may generate and display a dashboard which includes a layout of the shared environment being monitored including boundaries/walls that enclose various finite spaces within the shared environment. For example, the user interface 480 may display a layout of each finite space along with a health score of the finite space. In the example of FIG. 4C, a room 481 has a health score of 482 which is shown via the user interface 480.

Although not shown in FIG. 4C, the user interface 480 may include additional information such as a number of persons within each shared finite space, a heat map or other colored/shaded elements which depict “hot spots” of potential health risks within the shared environment, and the like. The user interface 480 may also identify whether a finite space is OK/cleared or whether the finite space is not to be accessed and an amount of time that the access is prevented (e.g., until the end of the day, etc.) The user interface 480 may be output from the host platform 420 to any of an administrator device, a user's mobile device (such as a user walking around in the shared environment), a kiosk, and the like. In addition, the user may also request that the kiosk be used to provide a current health score of the user.

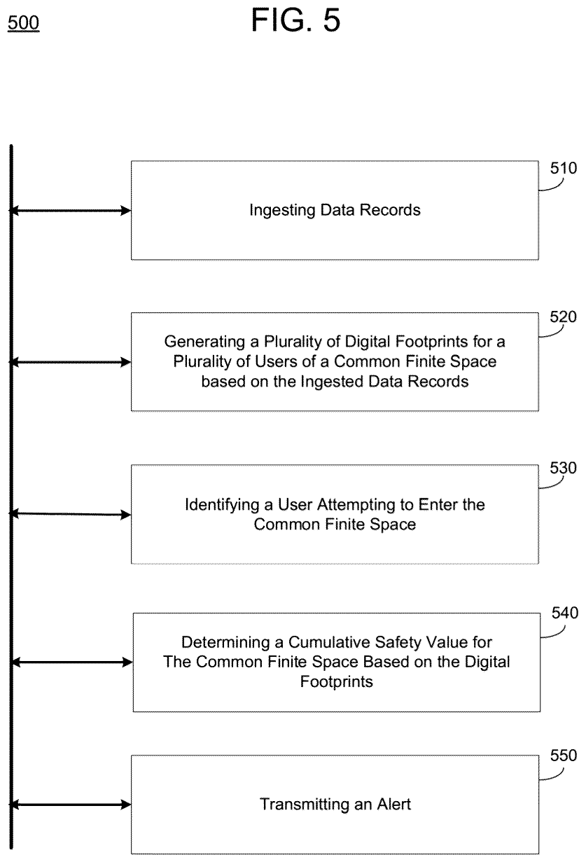

FIG. 5 illustrates a method 500 of determining safety based on a digital footprint according to an example embodiment. Referring to FIG. 5, in 510, the method may include ingesting user data records from a plurality of external data sources via a plurality of application programming interface (API) calls. In 520, the method may include generating a plurality of digital footprints for a plurality of users, respectively, which have access to a common finite space, wherein each digital footprint comprises a respective health value of a respective user generated based on ingested data records of the user.

In 530, the method may include identifying a user from among the plurality of users which is about to enter the common finite space. In response to identifying the user, in 540, the method may include determining a cumulative safety value for the common finite space based on the digital footprint of the identified user and a digital footprint of one or more other users already present within the common finite space. In 550, the method may include transmitting an alert to a computing system based on the determined cumulative safety value for the common finite space.

In some embodiments, the ingesting may include ingesting the data records via two or more of a travel database, a public database, a medical database, and documents input via a user interface. In some embodiments, the identifying may include detecting an input on a keypad associated with the common finite space, and identifying the user based on a keycode entered into the keypad. In some embodiments, the method may further include preventing a door of the common finite space associated with the keypad from being opened based on the determined cumulative safety value for the common finite space. In some embodiments, the identifying may include recognizing, via an imaging device, that the user is approaching the common finite space and is within a predetermined distance of a door to the common finite space.

In some embodiments, the method may further include displaying, via a user interface, a layout of the common finite space, identifiers of the one or more other users that are present in the common finite space within the layout, and health values associated with the one or more users. In some embodiments, the determining the cumulative safety value for the common finite space may include aggregating health scores for the user and the one or more users already present in the common space based on a bipartite model. In some embodiments, the method may further include detecting the user entering the common finite space, modifying a health value of a user from among the one or more users already present in the common finite space based on the digital footprint of the user and an amount of time the user has been present in the common finite space.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

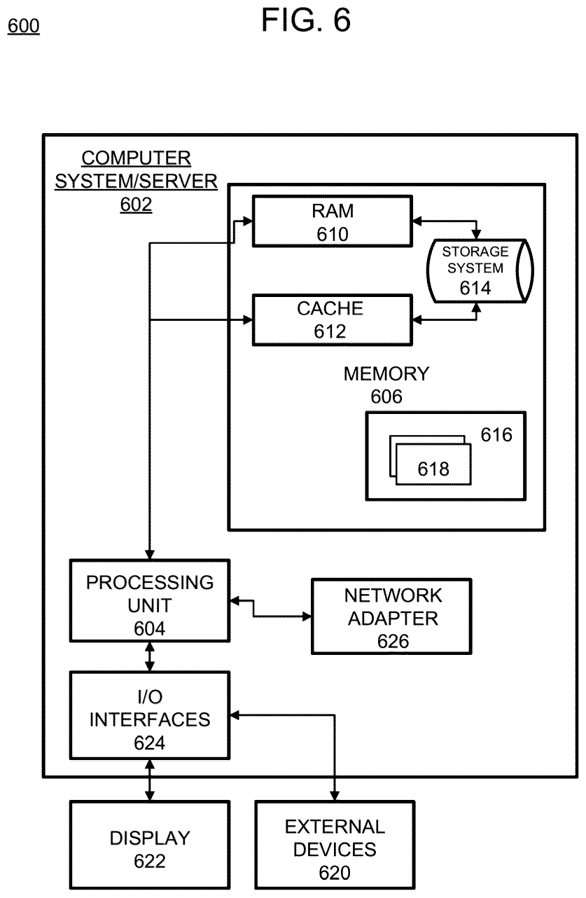

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components. For example, FIG. 6 illustrates an example computer system architecture 600, which may represent or be integrated in any of the above-described components, etc.

FIG. 6 illustrates an example system 600 that supports one or more of the example embodiments described and/or depicted herein. The system 600 comprises a computer system/server 602, which is operational with numerous other general purpose or special purpose computing system environments or configurations. Examples of well-known computing systems, environments, and/or configurations that may be suitable for use with computer system/server 602 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 6, computer system/server 602 in cloud computing node 600 is shown in the form of a general-purpose computing device. The components of computer system/server 602 may include, but are not limited to, one or more processors or processing units 604, a system memory 606, and a bus that couples various system components, including system memory 606 to processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media. System memory 606, in one embodiment, implements the flow diagrams of the other figures. The system memory 606 can include computer system readable media in the form of volatile memory, such as random-access memory (RAM) 610 and/or cache memory 612. Computer system/server 602 may further include other removable/non-removable, volatile/non-volatile computer system storage media. By way of example only, storage system 614 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility 616, having a set (at least one) of program modules 618, may be stored in memory 606 by way of example, and not limitation, as well as an operating system, one or more application programs, other program modules, and program data. Each of the operating system, one or more application programs, other program modules, and program data or some combination thereof may include an implementation of a networking environment. Program modules 618 generally carry out the functions and/or methodologies of various application embodiments as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 602 may also communicate with one or more external devices 620 such as a keyboard, a pointing device, a display 622, etc.; one or more devices that enable a user to interact with computer system/server 602; and/or any devices (e.g., network card, modem, etc.) that enable computer system/server 602 to communicate with one or more other computing devices. Such communication can occur via I/O interfaces 624. Still yet, computer system/server 602 can communicate with one or more networks such as a local area network (LAN), a general wide area network (WAN), and/or a public network (e.g., the Internet) via network adapter 626. As depicted, network adapter 626 communicates with the other components of computer system/server 602 via a bus. It should be understood that although not shown, other hardware and/or software components could be used in conjunction with computer system/server 602. Examples include, but are not limited to: microcode, device drivers, redundant processing units, external disk drive arrays, RAID systems, tape drives, data archival storage systems, etc.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a processor configured to ingest data records from a plurality of external data sources via a plurality of application programming interface (API) calls; and
a memory configured to store the ingested data records,
wherein the processor is further configured to
generate a plurality of digital footprints for a plurality of users, respectively, which have access to a common finite space, wherein each digital footprint comprises a respective health value of a respective user generated based on ingested data records of the user;
identify a user from among the plurality of users which is about to enter the common finite space;
in response to identification of the user, determine a cumulative safety value for the common finite space based on the digital footprint of the identified user and a digital footprint of one or more other users already present within the common finite space; and
transmit an alert to a computing system based on the determined cumulative safety value for the common finite space.

2. The apparatus of claim 1, wherein the processor is configured to ingest the data records via two or more of a travel database, a public database, a medical database, and documents input via a user interface.

3. The apparatus of claim 1, wherein the processor is configured to detect an input on a keypad associated with the common finite space, and identify the user based on a keycode entered into the keypad.

4. The apparatus of claim 3, wherein the processor is further configured to lock a door of the common finite space associated with the keypad based on the determined cumulative safety value for the common finite space.

5. The apparatus of claim 1, wherein the processor is configured to recognize, via an imaging device, that the user is near the common finite space and is within a predetermined distance of a door to the common finite space.

6. The apparatus of claim 1, wherein the processor is configured to display, via a user interface, a layout of the common finite space, identifiers of the one or more other users that are present in the common finite space within the layout, and health values associated with the one or more users.

7. The apparatus of claim 1, wherein the processor is configured to determine the cumulative safety value for the common finite space via aggregation of health scores for the user and the one or more users already present in the common space based on a bipartite model.

8. The apparatus of claim 1, wherein the processor is further configured to detect the user enter the common finite space, and modify a health value of a user from among the one or more users already present in the common finite space based on the digital footprint of the user and an amount of time the user has been present in the common finite space.

9. A method comprising:
ingesting data records from a plurality of external data sources via a plurality of application programming interface (API) calls;
generating a plurality of digital footprints for a plurality of users, respectively, which have access to a common finite space, wherein each digital footprint comprises a respective health value of a respective user generated based on ingested data records of the user;
identifying a user from among the plurality of users which is attempting to enter the common finite space;
in response to identifying the user, determining a cumulative safety value for the common finite space based on the digital footprint of the identified user and a digital footprint of one or more other users already present within the common finite space; and
transmitting an alert to a computing system based on the determined cumulative safety value for the common finite space.

10. The method of claim 9, wherein the ingesting comprises ingesting the data records via two or more of a travel database, a public database, a medical database, and documents input via a user interface.

11. The method of claim 9, wherein the identifying comprises detecting an input on a keypad associated with the common finite space, and identifying the user based on a keycode entered into the keypad.

12. The method of claim 11, wherein the method further comprises locking a door of the common finite space associated with the keypad based on the determined cumulative safety value for the common finite space.

13. The method of claim 9, wherein the identifying comprises recognizing, via an imaging device, that the user is near the common finite space and is within a predetermined distance of a door to the common finite space.

14. The method of claim 9, wherein the method further comprises displaying, via a user interface, a layout of the common finite space, identifiers of the one or more other users that are present in the common finite space within the layout, and health values associated with the one or more users.

15. The method of claim 9, wherein the determining the cumulative safety value for the common finite space comprises aggregating health scores for the user and the one or more users already present in the common space based on a bipartite model.

16. The method of claim 9, wherein the method further comprises detecting the user entering the common finite space, modifying a health value of a user from among the one or more users already present in the common finite space based on the digital footprint of the user and an amount of time the user has been present in the common finite space.

17. A computer-readable storage medium comprising instructions, that when read by a processor, cause the processor to perform a method comprising:
ingesting data records from a plurality of external data sources via a plurality of application programming interface (API) calls;
generating a plurality of digital footprints for a plurality of users, respectively, which have access to a common finite space, wherein each digital footprint comprises a respective health value of a respective user generated based on ingested data records of the user;
identifying a user from among the plurality of users which is about to enter the common finite space;
in response to identifying the user, determining a cumulative safety value for the common finite space based on the digital footprint of the identified user and a digital footprint of one or more other users already present within the common finite space; and
transmitting an alert to a computing system based on the determined cumulative safety value for the common finite space.

18. The computer-readable storage medium of claim 17, wherein the ingesting comprises ingesting the data records via two or more of a travel database, a public database, a medical database, and documents input via a user interface.

19. The computer-readable storage medium of claim 17, wherein the identifying comprises detecting an input on a keypad associated with the common finite space, and identifying the user based on a keycode entered into the keypad.

20. The computer-readable storage medium of claim 19, wherein the method further comprises locking a door of the common finite space associated with the keypad based on the determined cumulative safety value for the common finite space.
